(19) United States
(12) Patent Application Publication
(10) Pub. No.: US 2008/0229890 A1
(43) Pub. Date: Sep. 25, 2008

(54) Buoyant hand tool

(76) Inventor: Jiou-De Chen, Taichung Hsien (TW)

Correspondence Address: Jiou-De Chen, 235 Chung-Ho, Box 8-24, Taipei, TW

(21) Appl. No.: 11/726,045

(22) Filed: Mar. 21, 2007

(51) Int. Cl. B25B 23/16

(52) U.S. Cl. 81/177.1; 81/489

(57) ABSTRACT

A buoyant hand tool comprises a rod body having a driving portion and an insertion portion; a handle; the insertion portion of the rod body being inserted into the handle and being completely sealed; the handle having a chamber which is filled with air or is vacuumed; the chamber being completely sealed and being waterproof, and thus the buoyant hand tool is buoyant in water. A connection of the rod body and the handle has a protrusion seat which encloses the insertion portion. The driving portion has a cruciform head or a straight head, or the driving portion has a socked at a head thereof, or a ratchet at a head thereof, or a ring head or an opened head.

### FIELD OF THE INVENTION

The present invention relates to hand tools, and particularly to a buoyant hand tool which a chamber which is completely sealed. The chamber is filled with air or is vacuumed. In the present invention, the chamber is at the handle portion of the hand tool.

### BACKGROUND OF THE INVENTION

Generally, the hand tools, such as openers, or pliers, have solid handles. Some handles are formed with grooves for receiving some objects, but these kinds of the grooves are not completely sealed. Thus when they fall into water, they will sink into the water. However, in many cases the workers do works near water, such as work on a boat, or bridges. Thus it is very possible that the hand tools will fall into water and then sink into water.

Thus there is an eager demand for improving such kind of defect and thus the newly designed hand tools are necessary.

### SUMMARY OF THE INVENTION

Accordingly, the primary object of the present invention is to provide a buoyant hand tool which a chamber which is completely sealed. The chamber is filled with air or is vacuum. In the present invention, the chamber is at the handle portion of the hand tool.

To achieve above objects, the present invention provides a buoyant hand tool comprises a rod body having a driving portion and an insertion portion; a handle; the insertion portion of the rod body being inserted into the handle and being completely sealed; the handle having a chamber which is filled with air or is vacuumed; the chamber being completely sealed and being waterproof, and thus the buoyant hand tool is buoyant in water. A connection of the rod body and the handle has a protrusion seat which encloses the insertion portion. The driving portion has a cruciform head or a straight head, or the driving portion has a socked at a head thereof, or a ratchet at a head thereof, or a ring head or an opened head.

The various objects and advantages of the present invention will be more readily understood from the following detailed description when read in conjunction with the appended drawing.

### BRIEF DESCRIPTION OF THE DRAWINGS

FIG. 1 is an exploded perspective view of the buoyant hand tool of the present invention.

FIG. 2 is a perspective view of the buoyant hand tool of the present invention.

FIG. 3 is a schematic cross sectional view about the driving portion and insertion portion of the present invention.

FIG. 4 is a schematic view about the buoyant hand tool of the present invention.

FIGS. 5 to 8 are schematic views showing the buoyant hand tool of the present invention, which have different heads.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

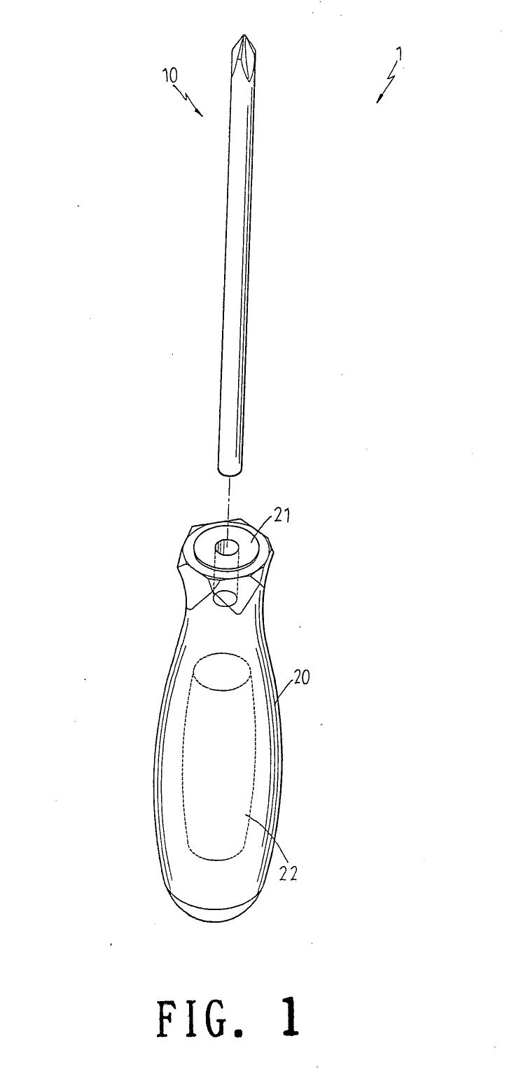

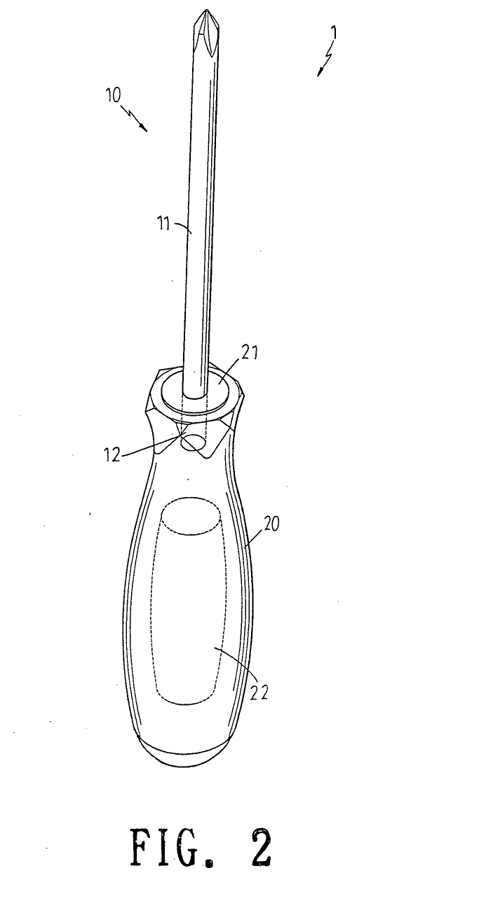

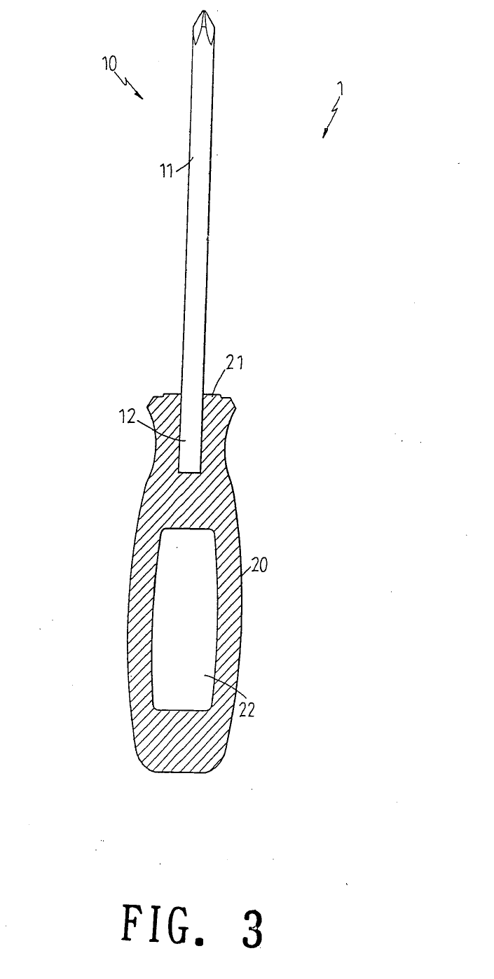

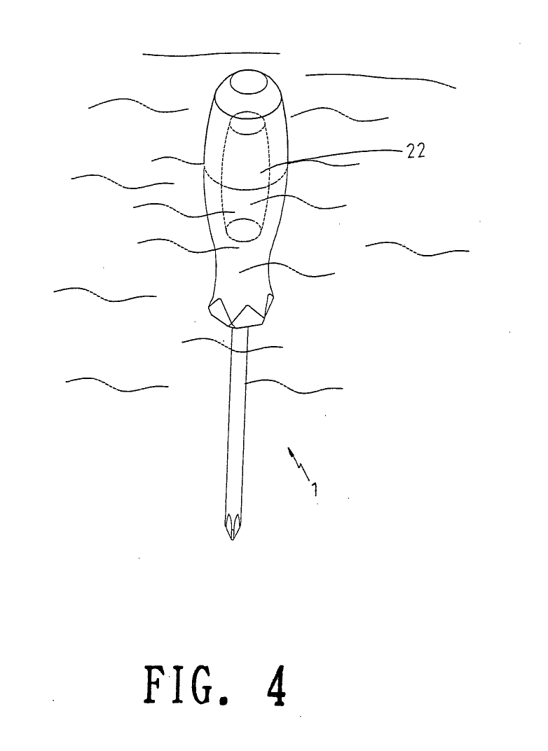

Referring to FIGS. 1 and 2, the buoyant hand tool of the present invention is illustrated. The present invention has the following elements.

A rod body 10 has a driving portion 11 and an insertion portion 12.

A handle 20 has a protrusion seat 21. The insertion portion 12 of the rod body 10 is embedded into the handle 20. The protrusion seat 21 encloses the insertion portion 12 completely so that the rod body 10 and the handle 20 are combined completely. In operation, the rod body 10 will not separate from the handle 20.

An interior of the handle 20 has a completely sealed chamber 22. The chamber 22 is filled with air or a vacuumed. Thus when the hand tool 1 of the present invention is sunk into water, the hand tool is buoyant on the water surface. Other than the chamber 22, other part of the handle 20 has a solid structure. Thereby since the handle has a hollow chamber 22, it is light and thus is convenient in carry out.

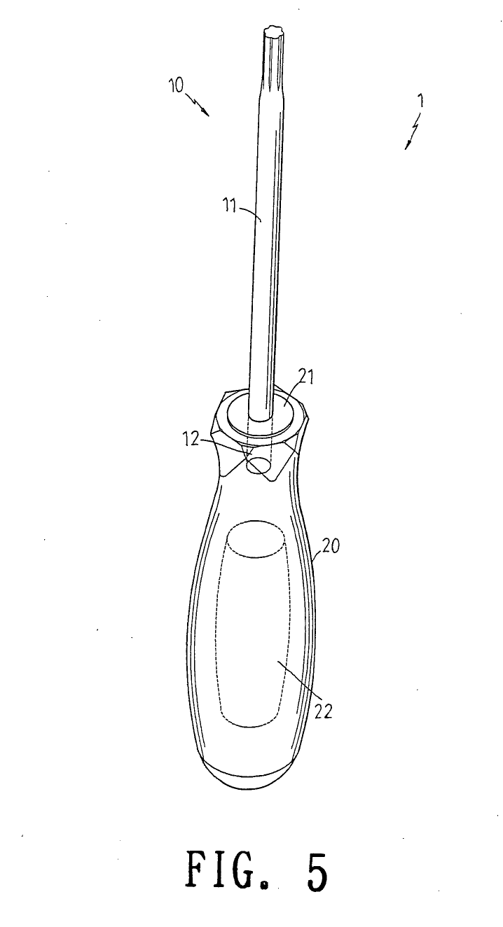

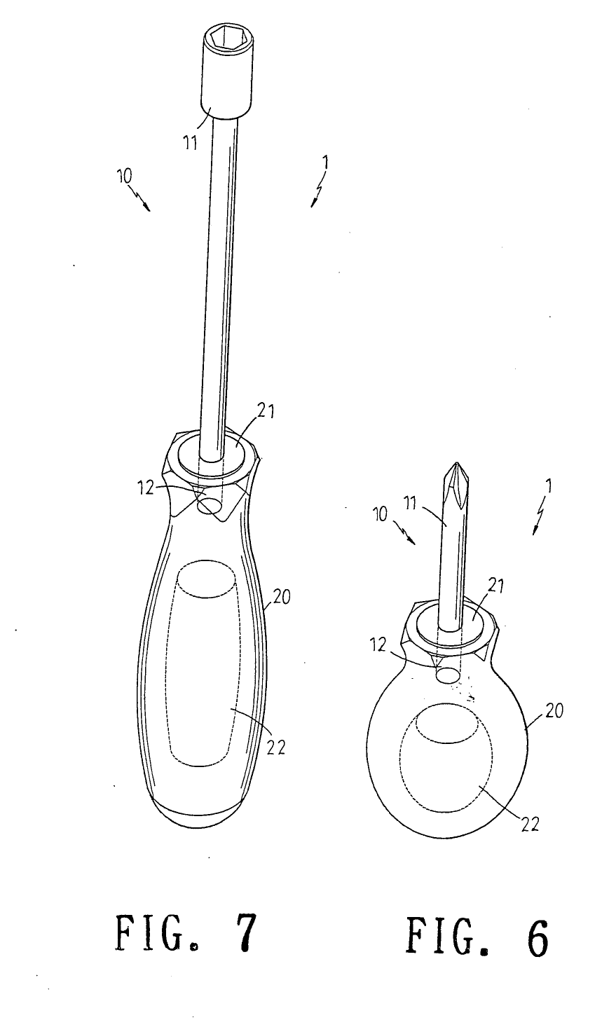

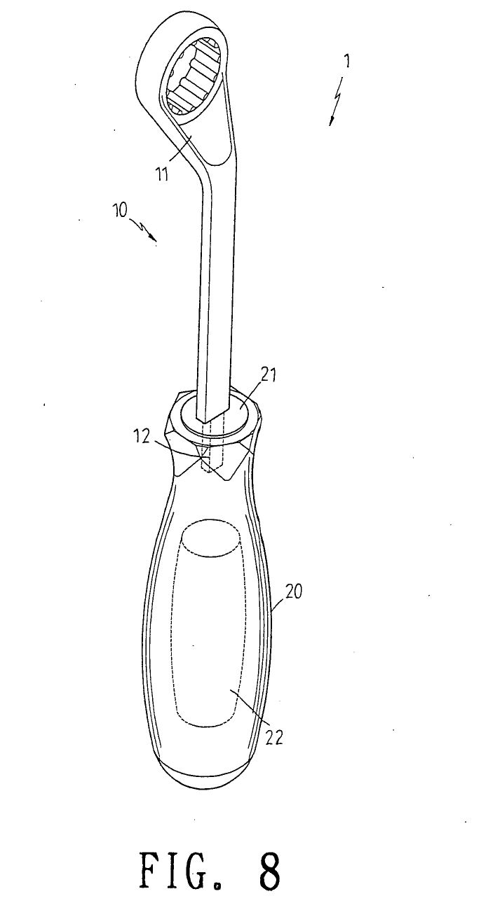

The driving portion 11 may has a cruciform head or a straight head. Furthermore referring to FIG. 5, the second embodiment of the present invention is illustrated. In this embodiment, those identical to the above mentioned embodiment will not be further described herein. Only those difference are disclosed. In this the present invention, the head of the driving portion 11 has a flower shape head. FIGS. 6 to 8 show other embodiments of the present invention. In these embodiments, those identical to the above mentioned embodiment will not be further described herein. Only those difference are disclosed. In FIG. 6, it is illustrated that the hand tool has a short handle. In FIG. 7, it is illustrated that the driving portion 11 has a socket head. In FIG. 8, it is illustrated that the driving portion 11 has a ratchet head.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A buoyant hand tool comprising:
a rod body having a driving portion and an insertion portion;
a handle; the insertion portion of the rod body being inserted into the handle and being completely sealed; the handle having a chamber which is filled with air or is vacuumed; the chamber being completely sealed and being waterproof, and thus the buoyant hand tool is buoyant in water.

2. The buoyant hand tool as claimed in claim 1, wherein a connection of the rod body and the handle has a protrusion seat which encloses the insertion portion.

3. The buoyant hand tool as claimed in claim 1, wherein the driving portion has a cruciform head.

4. The buoyant hand tool as claimed in claim 1, wherein the driving portion has a straight head.

5. The buoyant hand tool as claimed in claim 1, wherein the driving portion has a socked at a head thereof.

6. The buoyant hand tool as claimed in claim 1, wherein the driving portion has a ratchet at a head thereof.

7. The buoyant hand tool as claimed in claim 1, wherein the driving portion has a ring head.

8. The buoyant hand tool as claimed in claim 1, wherein the driving portion is an opened head.
